(19) United States
(12) Patent Application Publication
(10) Pub. No.: US 2021/0256476 A1
(43) Pub. Date: Aug. 19, 2021

(54) ELECTRONIC CONTACT MANAGEMENT SYSTEM

(71) Applicant: Tinkit, LLC, Bellevue, WA (US)

(72) Inventor: Michael Mpare, Bellevue, WA (US)

(21) Appl. No.: 17/178,711

(22) Filed: Feb. 18, 2021

Related U.S. Application Data
(60) Provisional application No. 62/978,525, filed on Feb. 19, 2020.

(51) Int. Cl. G06Q 10/10; H04W 4/029; H04W 76/14; H04W 4/80; G06K 19/06

(52) U.S. Cl. CPC G06Q 10/105; H04W 4/029; G06K 19/06018; H04W 4/80; G06K 19/06037; H04W 76/14

(57) ABSTRACT

An electronic contact management system where application users create, manage, and update electronic contact cards. The electronic contact card management system uses a handshake exchange or unique electronic identifiers to allow users to share and/or exchange their electronic contact cards with others. Contact information is stored on a remote computing device and accessed through web applications or portals in a digital rolodex. When a user of the system updates their contact information, the system updates their electronic contact card, thereby updating each digital rolodex. The system consolidates all of the user's contacts into an intuitive and intelligent contact book, providing quick access to communicate with connections made in their professional or social circles. The system maintains, updates, and adds to the user's contact information as a contact's information is changed or updated.

### CROSS-REFERENCE TO RELATED APPLICATIONS

This application claims the benefit of and priority to U.S. Provisional Application No. 62/978,525, filed Feb. 19, 2020, which is hereby incorporated by reference in its entirety for all purposes.

### BACKGROUND OF THE INVENTION

Business cards, rolodexes, and contact lists are used to store contact information. The user must store, update, and maintain their contact information by replacing or manually updating each entry.

### BRIEF SUMMARY OF THE INVENTION

An electronic contact management system where application users are offered versatile or simple designs to create, manage, and update electronic contact cards. The electronic contact card management system uses a digital handshake, which allows users to share and/or exchange their electronic contact cards effortlessly and contactlessly with others. Contact information is stored on a remote computing device and accessed through web applications or portals. By using the electronic contact card management system and creating a digital rolodex, users can easily stay connected with all of their contacts. When a user of the system updates their contact information, the system updates their electronic contact card, thereby updating each digital rolodex. The system consolidates all of the user's contacts into an intuitive and intelligent contact book, providing quick access to communicate with connections made in their professional or social circles. The system maintains, updates, and adds to the user's contact information as a contact's information is changed or updated. Users may also participate in a paid subscription model. Having a subscription allows a user to build on their business brand and unite all of their team members by using a universal card, where any changes made to the universal company card will update automatically to all members of the team.

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described. but this description is not necessarily intended to limit the scope of future claims. The subject matter to be claimed may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. The illustrative examples are given to introduce the reader to the general subject matter discussed herein and not intended to limit the scope of the disclosed concepts. The following sections describe various additional examples and examples with reference to the drawings in which like numerals indicate like elements and directional description are used to describe illustrative examples but, like the illustrative examples, should not be used to limit the present disclosure.

### BRIEF DESCRIPTION OF THE DRAWINGS

Various embodiments in accordance with the present disclosure will be described with reference to the drawings, in which:

FIG. 1 depicts an example system for exchanging and tracking electronic contact cards, according to at least one example;

FIG. 2 depicts an example system architecture for implementing techniques related to exchange and tracking of electronic contact cards, according to at least one example;

FIG. 3 depicts an example user interface of a mobile device application for viewing and exchanging an electronic contact card, according to at least one example;

FIG. 4 depicts an example user interface for sharing an electronic contact card, according to at least one example;

FIG. 5 depicts an example user interface for designing an electronic contact card, according to at least one example;

FIG. 6 depicts an example user interface for viewing electronic contact card analytics, according to at least one example;

FIG. 7 depicts an example user interface for viewing notifications and reminders associated with electronic contact cards, according to at least one example;

FIG. 8 depicts an example web portal for managing a business group of an electronic contact management system, according to at least one example;

FIG. 9 depicts an example flowchart for a process of exchanging electronic contact cards, according to at least one example;

FIG. 10 depicts an example computing system for implementing one or more techniques described herein, according to at least one example.

### DETAILED DESCRIPTION OF THE INVENTION

Examples of the present disclosure relate to systems, methods, and devices related to an electronic contact management system. Specifically, the present disclosure relates to a centralized, maintained electronic contact card system for generating, accessing, and updating a digital rolodex as well as systems and methods for exchanging electronic contact cards and generating the digital rolodex.

In one illustrative example, a user creates, designs, and shares an electronic contact card through the use of a computing device and at least one software module. The software module allows a user to input their contact information, choose designs, and share their personalized electronic contact card with others. Shared contact information is stored in an electronic contact management system and/or database which references each user's contact information to provide up to date contact and other personal information about each user. The database may be stored on a remote computing device such as a server or other such electronic device. Through the use of a software module, users are able to access their personal contact information and electronic contact cards to update, re-design, or share, as well as access their listing or database of contacts whose electronic contact cards they have received. Users may also be able to add or import electronic contact cards for existing contacts kept in other databases as well. As contact information for any user is updated, or their electronic contact card is changed, the updated and/or new electronic contact card is propagated through the database at the back end server and subsequently pushed out to update individual contact lists accessible through the software portal. Accordingly, once a user has exchanged and/or received an electronic contact card from another individual, any subsequent updates or changes to their electronic contact card, including contact information, employment location and or information, any relevant personal information, or any other information added to the electronic contact card is kept constantly up to date. This up to date rolodex ensures that once individuals have exchanged contact information they are able to maintain contact and communication regardless of any changes to contact information that may occur as a result of changing jobs, phone numbers, email address, or mailing addresses.

The electronic contact cards can be transmitted electronically or may be shared through a handshake or communication link. The handshake and/or optical communication link allows two computing devices to each simultaneously present or produce a unique digital identifier and read or receive a unique digital identifier from the other computing device. The optical communication link uses a particular display layout to present or produce the unique digital identifier and simultaneously uses a camera or optical device of the computing device to read or receive the digital identifier from the other computing device. The unique digital identifier may include a quick response (“QR”) code or any other suitable unique digital identifier such as an image, a barcode, or any other unique identifier.

The electronic contact cards may be updated with updates propagated throughout a system or collection of electronic contact cards. In this manner, once an electronic contact card is exchanged between user devices, contact information associated with the user devices may be updated throughout an entire system, ensuring that even through title, position, job, and contact information changes, the user's may remain in contact with one another. As a result, individuals may remain in contact with one another and remain relevant to one another and in touch more easily than through the user of typical systems.

As a further improvement over conventional systems, the use of an electronic contact card, and an exchange handshake between user devices avoids physical contact between exchanged contact information. For example, during a time of sickness, such as a flu or other communicable disease, users may wish to avoid exchanging physical business cards which may be contaminated. Additionally, the exchange handshake further ensures that such exchanged contact information remains up to date in a manner not possible with physical cards or other conventional systems. The systems described herein may further enable interactions between users to remain in contact, to make introductions to third parties, and other such interactions. The use of electronic contact cards may also reduce paper waste associated with physical contact cards that may quickly become obsolete.

Additional benefits of the techniques and systems described herein may include additional functionality for viewing contact information, messages, alerts, and location information associated with user devices. For example, at a convention or conference, booths or users may wish to easily share pamphlets, information, videos, introductory information, and other such data with users at the convention. Various user devices may receive, for example through the use of an image sensor, references to electronic contact cards and associated data, such as videos as they traverse a convention center. In such examples, an augmented reality view of the scene may be presented including selectable links and/or options to view, access, store, and interact with electronic contact cards and other such information based on visible codes presented by other users. In some examples, the information described above may be distributed or shared with an entire rolodex or collection of contacts. For example, when an artist or other producer wishes to provide any update of information, contact information, upcoming release of a product, or other such data, the user may propagate an alert throughout their digital rolodex, to each of the contacts associated with electronic contact cards stored in the digital rolodex.

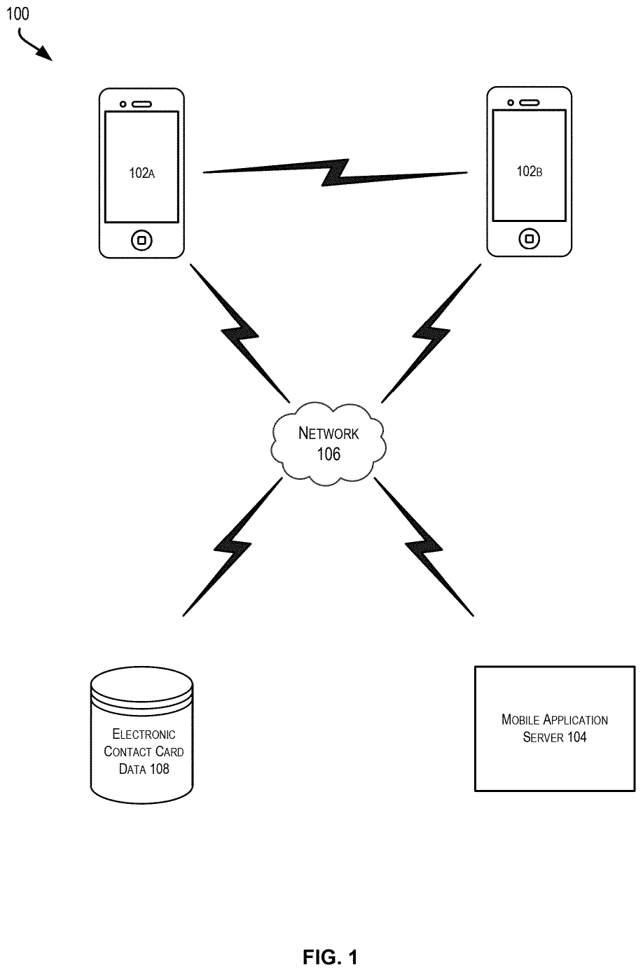

Turning now to the figures, FIG. 1 depicts an example system 100 for exchanging and tracking electronic contact cards, according to at least one example. In FIG. 1, a first user device 102a may be used to generate, share, and interact with electronic contact cards, a second user device 102b, a database of electronic contact card data 108, and a mobile application server 104. The user devices 102a and 102b (collectively user device 102), may be used to obtain user data which may be provided to the mobile application server 104 over network 106. The user device 102 may interact with other user devices 102 to exchange electronic contact cards and references thereto. The mobile application server 104 may be configured to receive data from the user device 102 and store, update, or otherwise interact with electronic contact card data 108. The mobile application server 104 may, in some examples, provide a digital rolodex of electronic contact cards collected at user device 102 and may update the digital rolodex as additional electronic contact cards are received, shared, and updated with additional or different information.

In an example the user device 102 represents a suitable computing device that includes one or more processing units and one or more memories storing computer-readable instructions that are executable by at least one of the processing units to perform various functionalities of the embodiments of the present description. For instance, the user device 102 can be any of a smartphone, a tablet, a laptop, a personal computer, a gaming console, or a smart television. The user device 102 may additionally include an image sensor, such as an RGB optical sensor or camera and a display or other output device.

The user device 102 may be used to receive and/or generate electronic contact card data 108. The electronic contact card data 108 may include information related to a particular user (e.g., a user of the user device 102) for which contact information may be shared or updated with one or more contacts or acquaintances. For example, the electronic contact card data 108 may include contact information such as a phone number, email address, website, job position, employment information, and other such information. In some examples, the electronic contact card data 108 may include additional information or data such as photo, video, or text data associated with the user of the user device 102.

The mobile application server 104 may include any computing device capable of receiving, conveying, manipulating, and interacting with electronic contact card data 108 in accordance with the techniques described herein. In order to interact with the electronic contact card data 108, the mobile application server 104 may receive data from the user device 102 over network 106. The mobile application server 104 may include any arrangement of software, hardware, computing systems, or such systems and devices.

In an example, the first user device 102a may be used to generate a first electronic contact card and convey the first electronic contact card to the mobile application server 104 for storage with the electronic contact card data 108. The first electronic contact card may include contact data to communicate with a user associated with the first user device 102a. The second user device 102b may be used to generate a second electronic contact card and convey the second electronic contact card to the mobile application server 104. During an interaction between the first user device 102a and the second user device 102b, an exchange handshake is established between the user devices 102. The exchange handshake provides for communication of the first electronic contact card and the second electronic contact card between the first user device 102a and the second user device 102b. The exchange may be performed by communicating over a near-field communication system. In some examples, the exchange may be performed over a BLUETOOTH® communication. In some examples, the first user device 102a may display a reference or code, such as a QR code, barcode, or other such visual code associated with the first electronic contact card. The second user device 102b may display a similar reference code associated with the second electronic contact card. During the exchange, an image sensor of the first user device 102a may capture or receive the reference code from the second user device 102b and an image sensor of the second user device 102b may capture or receive the reference code from the first user device 102a. By exchanging the reference codes, the first user device 102a and the second user device 102b communicate with the mobile application server 104 to update a digital rolodex associated with each of the user devices 102 to include the new electronic contact card data. The digital rolodex associated with the first user device 102a may include a reference to the second electronic contact card following the exchange handshake and the digital rolodex associated with the second user device 102b may include the reference to the first electronic contact card.

Following the exchange between the first user device 102a and the second user device 102b, any subsequent updates of information associated with the electronic contact cards is propagated to each digital rolodex including a reference to the electronic contact card that is updated. For example, after the exchange, the first user device 102 may be used to update contact information of the first electronic contact card. Following the change, the electronic contact card data 108 may be updated in accordance with the update via the mobile application server 104. Subsequently, any and all digital rolodexes including a reference to or a copy of the first electronic contact card are automatically updated to include the updated first electronic contact card data. In this manner, contact information for users and other such data are constantly up to date and usable for interacting with other users.

In some examples, additional features or functionality may be provided through the mobile application server 104, such as sharing of information with one or more users whose electronic contact cards are stored in the digital rolodex of the first user device 102a. Other features, such as providing introductions to a third party and sharing of location data of one or more users may further reduce burdens to communication and connections between users.

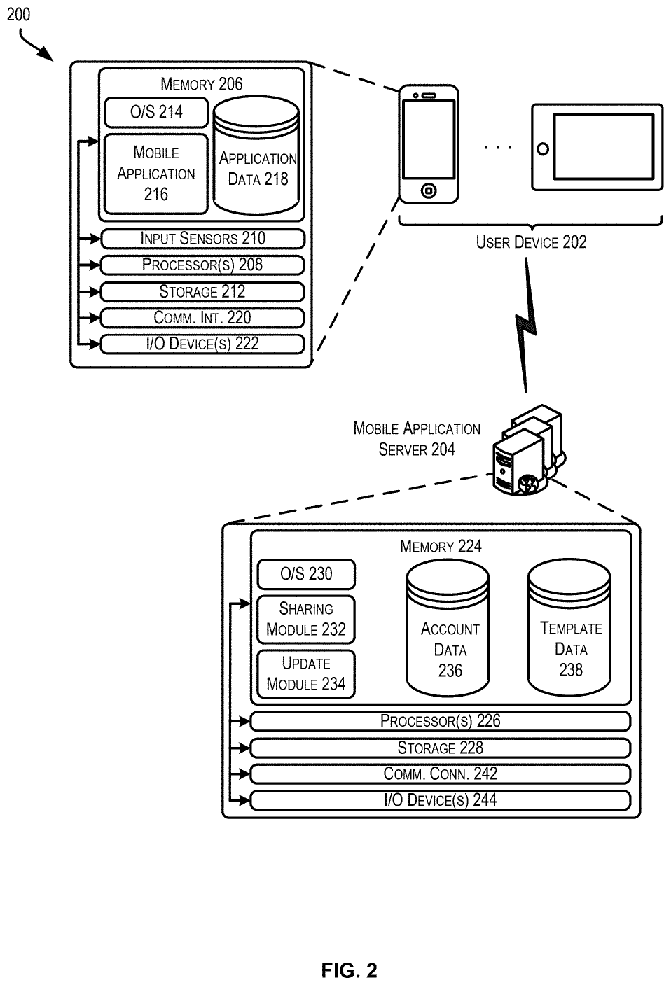

FIG. 2 depicts an example system architecture 200 for implementing techniques related to exchange and tracking of electronic contact cards, according to at least one example. In FIG. 2, a user device 202 may be in communication with a number of other components, including at least a mobile application server 204. The mobile application server 204 may perform at least a portion of the processing functions required by a mobile application installed upon the user device 202. The user device 202 and mobile application server 204 may be examples of the user device 102 and mobile application server 104 respectively described with respect to FIG. 1.

A user device 202 may be any suitable electronic device that is capable of providing at least a portion of the capabilities described herein. In particular, the user device 202 may be any electronic device capable of capturing user data and/or presenting a rendered image. In some embodiments, a user device may be capable of establishing a communication session with another electronic device (e.g., mobile application server 204 or other user device 202) and transmitting/receiving data from that electronic device. A user device may include the ability to download and/or execute mobile applications. User devices may include mobile communication devices as well as personal computers and thin-client devices. In some embodiments, a user device may comprise any portable electronic device that has a primary function related to communication. For example, a user device may be a smart phone, a personal data assistant (PDA), or any other suitable handheld device. The user device can be implemented as a self-contained unit with various components (e.g., input sensors, one or more processors, memory, etc.) integrated into the user device. Reference in this disclosure to an “output” of a component or an “output” of a sensor does not necessarily imply that the output is transmitted outside of the user device. Outputs of various components might remain inside a self-contained unit that defines a user device.

In one illustrative configuration, the user device 202 may include at least one memory 206 and one or more processing units (or processor(s)) 208. The processor(s) 208 may be implemented as appropriate in hardware, computer-executable instructions, firmware or combinations thereof. Computer-executable instruction or firmware implementations of the processor(s) 208 may include computer-executable or machine executable instructions written in any suitable programming language to perform the various functions described. The user device 202 may also include one or more input sensors 210 for receiving user and/or environmental input. There may be a variety of input sensors 210 capable of detecting user or environmental input, such as an accelerometer, a camera device, a depth sensor, a microphone, a global positioning system (e.g., GPS) receiver, etc. The one or more input sensors 210 may include a range camera device (e.g., a depth sensor) capable of generating a range image, as well as a camera device configured to capture image information.

The memory 206 may store program instructions that are loadable and executable on the processor(s) 208, as well as data generated during the execution of these programs. Depending on the configuration and type of user device 202, the memory 206 may be volatile (such as random access memory (RAM)) and/or non-volatile (such as read-only memory (ROM), flash memory, etc.). The user device 202 may also include additional storage 212, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 206 may include multiple different types of memory, such as static random access memory (SRAM), dynamic random access memory (DRAM) or ROM. Turning to the contents of the memory 206 in more detail, the memory 206 may include an operating system 214 and one or more application programs or services for implementing the features disclosed herein including at least a mobile application 216. The memory 206 may also include application data 218, which provides information to be generated by and/or consumed by the mobile application 216. In some embodiments, the application data 218 may be stored in a database. The application data 218 may include a representation of a digital rolodex associated with the user device 202.

For the purposes of this disclosure, a mobile application may be any set of computer executable instructions installed upon, and executed from, a user device 202. Mobile applications may be installed on a user device by a manufacturer of the user device or by another entity. In some embodiments, the mobile application 216 may cause a user device to establish a communication session with a mobile application server 204 that provides backend support for the mobile application 216. A mobile application server 204 may maintain account information associated with a particular user device and/or user including electronic contact cards and digital rolodex data. In some embodiments, a user may be required to log into a mobile application in order to access functionality provided by the mobile application 216.

In accordance with at least some embodiments, the mobile application 216 is configured to provide user information to the mobile application server 204 and to present information received from the mobile application server 204 to a user. More particularly, the mobile application 216 is configured to receive references or indicia indicative of a received electronic contact card and establish a relation between the digital rolodex associated with a first user and an electronic contact card of a second user. The mobile application 216 may update electronic contact card information in a digital rolodex as the electronic contact card information is updated by a user.

The user device 202 may also contain communications interface(s) 220 that enable the user device 202 to communicate with any other suitable electronic devices. In some embodiments, the communication interface 220 may enable the user device 202 to communicate with other electronic devices on a network (e.g., on a private network). For example, the user device 202 may include a Bluetooth wireless communication module, which allows it to communicate with another electronic device. The user device 202 may also include input/output (I/O) device(s) and/or ports 222, such as for enabling connection with a keyboard, a mouse, a pen, a voice input device, a touch input device, a display, speakers, a printer, etc.

In some embodiments, the user device 202 may communicate with the mobile application server 204 via a communication network. The communication network may include any one or a combination of many different types of networks, such as cable networks, the Internet, wireless networks, cellular networks, and other private and/or public networks. In addition, the communication network may comprise multiple different networks. For example, the user device 202 may utilize a wireless local area network (WLAN) to communicate with a wireless router, which may then route the communication over a public network (e.g., the Internet) to the mobile application server 204.

The mobile application server 204 may be any computing device or plurality of computing devices configured to perform one or more calculations on behalf of the mobile application 216 on the user device 202. In some embodiments, the mobile application 216 may be in periodic communication with the mobile application server 204. For example, the mobile application 216 may receive updates, push notifications, or other instructions from the mobile application server 204. In some embodiments, the mobile application 216 and mobile application server 204 may utilize a proprietary encryption and/or decryption scheme to secure communications between the two. In some embodiments, the mobile application server 204 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud-computing environment.

In one illustrative configuration, the mobile application server 204 may include at least one memory 224 and one or more processing units (or processor(s)) 226. The processor(s) 226 may be implemented as appropriate in hardware, computer-executable instructions, firmware or combinations thereof. Computer-executable instruction or firmware implementations of the processor(s) 226 may include computer-executable or machine executable instructions written in any suitable programming language to perform the various functions described.

The memory 224 may store program instructions that are loadable and executable on the processor(s) 226, as well as data generated during the execution of these programs. Depending on the configuration and type of mobile application server 204, the memory 224 may be volatile (such as random access memory (RAM)) and/or non-volatile (such as read-only memory (ROM), flash memory, etc.). The mobile application server 204 may also include additional storage 228, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 224 may include multiple different types of memory, such as static random access memory (SRAM), dynamic random access memory (DRAM) or ROM.

Turning to the contents of the memory 224 in more detail, the memory 224 may include an operating system 230 and one or more application programs or services for implementing the features disclosed herein including at least a sharing module 232 for sharing and exchanging electronic contact cards and related data between different user devices 202 and/or an update module 234 for receiving updates and additional information associated with a particular electronic contact card and propagating such additional information throughout a plurality of digital rolodexes or databases including associated data stores of electronic contact cards. The memory 224 may also include account data 236, which provides information associated with user accounts maintained by the described system, contact information, user data, and other such data and/or template data for creating and updating new electronic contact cards at the user device 202. In some embodiments, one or more of the account data 236 and the template data 238 may be stored in a database.

The memory 224 and the additional storage 228, both removable and non-removable, are examples of computer-readable storage media. For example, computer-readable storage media may include volatile or non-volatile, removable or non-removable media implemented in any method or technology for storage of information such as computer-readable instructions, data structures, program modules or other data. As used herein, the term “modules” may refer to programming modules executed by computing systems (e.g., processors) that are installed on and/or executed from the mobile application server 204. The mobile application server 204 may also contain communications connection(s) 242 that allow the mobile application server 204 to communicate with a stored database, another computing device or server, user terminals, and/or other components of the described system. The mobile application server 204 may also include input/output (I/O) device(s) and/or ports 244, such as for enabling connection with a keyboard, a mouse, a pen, a voice input device, a touch input device, a display, speakers, a printer, etc.

In some embodiments, the sharing module 232 may be configured to, in conjunction with the processors 226, exchange electronic contact cards between user devices 202, such as by establishing an exchange handshake as described herein. The exchange handshake may be accomplished through a near-field communication network, BLUETOOTH®, optical sensors, and other such data exchange systems between different user devices 202.

In some embodiments, the update module 234 may be configured to, in conjunction with the processors 226, provide updates through a remote computing system to a plurality of user rolodexes to update the contact information and maintain each of the digital rolodexes up to date with changes in contact information.

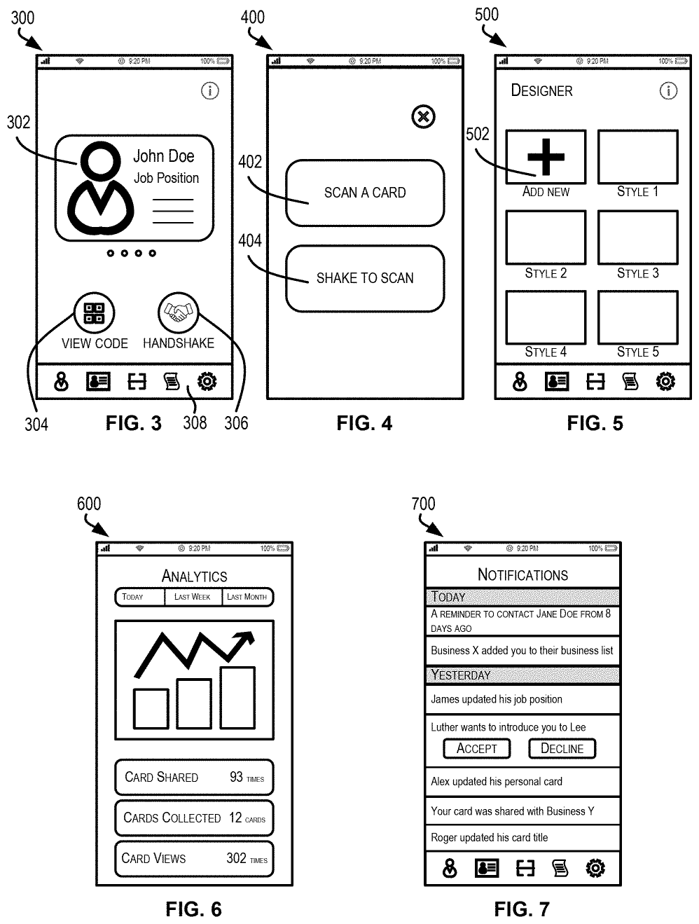

FIG. 3 depicts an example user interface 300 of a mobile device application for viewing and exchanging an electronic contact card, according to at least one example. The user interface 300 shown is just one example environment in which the system may operate. The user interface 300 may be implemented on a user device, such as user device 102 or 202 described herein. The system may operate on many different computing devices such as, but not limited to, a mobile phone, a smart phone, a personal digital assistant (PDA), a laptop computer, a desktop computer, a server computer, a thin-client device, a tablet PC, etc. Additionally, it should be noted that in some examples, the computing device may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment or distributed computing environment. The computing device may include one or more servers, perhaps arranged in a cluster or as individual servers not associated with one another.

The software module and/or application shown in the example user interface 300 of FIG. 3 presents a main screen showing optional activities and information to the user. The application in this embodiment can be used to navigate to other features of the software module and also provides a view of the user's current digital rolodex. In some examples, a first digital object 302 may include a representation of an electronic contact card, such as one associated with a user selected for viewing in the user interface 300 or associated with a user of the user device. Additional features 308 may include options to view a digital rolodex including electronic contact cards of contacts received by the user. In the digital rolodex, each electronic contact card is displayed having the chosen or selected contact information presented. The electronic contact cards in the digital rolodex have the appearance and design selected by each individual, or in other words, the electronic contact cards are presented in the digital rolodex in the same layout as they have been created. In other embodiments, the electronic contact cards may present the information differently and/or only present a selection of the information. Through user interactions, the application may display additional details and/or information about each individual, such as by tapping or selecting their electronic contact card. The additional features 308 may include options for adjusting user settings, viewing a personal electronic contact card, scanning reference indicia associated with other digital contact cards, and the like. The application provides navigation buttons and/or options to navigate to additional features of the software module, such as a settings page, a contact book, a card design tool, a notification page, and a sharing tool. Functions of each of these portions of the software application and/or module are described further below.

In some examples, the user interface 300 includes a representation of the digital rolodex shown as a scrollable list or stack of electronic contact cards, imitating physical business cards. In other embodiments of the application, the electronic contact cards may be presented as tiles arranged in a rectangular array, in a list, in columns, or any other suitable arrangement for easily searching and viewing the cards.

In some examples, the user interface 300 includes a first interface 304 for viewing or presenting a code. The code may be associated with an electronic contact card of the user associated with the user device. The code may be an optical code, a QR code, a barcode, or other such optical code for scanning by a separate user device. The user interface 300 may include a second interface 306 for initiating a handshake between user devices. In some examples, the handshake may cause two or more user devices positioned within a limited threshold distance to communicate and exchange references to electronic contact cards. In some examples, the handshake may cause the user devices to present an optical code on a display of the user device and simultaneously, or around the same time, activate an image sensor of the user device to capture image data including the optical code presented on a display of one or more other user devices.

FIG. 4 depicts an example user interface 400 for sharing an electronic contact card, according to at least one example. The user interface 400 may be part of the software module described above or may be a standalone application solely for the purpose of sharing or exchanging electronic contact cards. The user interface 400 presents options to scan a card or to commence a handshake, as well as other navigational features of the application. When the scan option is selected, a camera or other optical device of the mobile device is activated to receive or capture an image of an electronic contact card displayed by a separate computing device. In some embodiments, the camera may capture an image of a physical card and/or object which has a unique identifier located thereon which provides a link to an electronic contact card. The application may also present, or generate a display of a unique identifier tied to an electronic contact card.

In some examples, the user interface 400 may present or display a unique identifier associated with any electronic contact card in a digital rolodex. For example, an individual may refer a second individual to a third party by displaying the unique identifier of the third party for the second individual to scan and thereby receive the electronic contact card into their digital rolodex.

The user interface 400 may cause the user device to perform a handshake or simultaneous exchange of electronic contact cards and/or identifiers associated therewith between two separate computing devices. After selecting the handshake option in the mobile application of each of the devices to exchange information, the two computing devices are brought together to simultaneously present a unique identifier and scan and/or receive the unique identifier from the other computing device. In the case of mobile phones, the handshake may be performed by enabling a front facing camera on each of the mobile phones while simultaneously displaying a unique identifier such as a QR code on the display of each mobile phone. When the mobile phones are positioned with their displays oriented towards each other, the forward facing camera of each is able to capture the displayed unique identifier and still present a unique identifier of its own. In some examples, a notification, such as an audible and/or tactile notification may indicate to the users that the handshake and/or exchange of electronic contact cards has been successful.

FIG. 5 depicts an example user interface 500 for designing an electronic contact card, according to at least one example. The user interface 500 may provide the user with access to a digital storefront. The digital storefront provides pre-populated templates that are free for use, but also provides additional templates that are available for purchase. In addition, the storefront includes an open platform, so developers can design their own templates for electronic contact cards to be sold in the storefront.

The design module may be configured to build a user's contact list by inputting information for existing contacts that the user would like to add to their digital rolodex as well as for designing a user's own personal electronic contact card for sharing with others. The user may select a function to either add or create new electronic contact cards selecting from templates, edit existing electronic contact cards and/or delete any existing electronic contact cards. In some examples, the electronic contact cards can be labeled differently to differentiate the card type (i.e. one card may be created as a personal card reflecting personal contact information and a photo; a second card that is created for a business providing the user's business contact information and user's company logo and branding).

In some examples, when designing a new electronic contact card, based on the template type utilized or selected, the card may automatically populate the template design with a photo, information, tags and user card analytics. The card includes have a button to populate a digital QR code for sharing as described above. In some examples, the card may include features and elements for interaction. For example, the user may be able to call a phone number by tapping or selecting a phone number on the electronic contact card from within the application. Additionally, the user may have an option to set a privacy setting of the electronic contact card, such as to prevent sharing or limit sharing in some way. The user interface 500 may also present options to view the unique identifier associated with the electronic contact card, share the card, delete the card, cancel an action, and other navigational options within the application.

In some examples, the may also provide analytics for the selected card as shown and described with respect to FIG. 6. For example, the analytics may include information such as the number of times that particular card has been shared and how many times the card has been viewed by others. The analytics may include more information related to the number of users who have that particular card stored in their rolodex or other relevant information relating to the use of the electronic contact card.

FIG. 6 depicts an example user interface 600 for viewing electronic contact card analytics, according to at least one example. The user interface 600 may be configured for displaying analytics and data related to usage, collection, and exchanges of electronic contact cards. In particular, the analytics gathered by the remote server, mobile application server 104, and/or computing device as described herein may include tracking the number of times a particular electronic contact card is shared, viewed, collected, exchanged, sent, or otherwise interacted with. A user may view such data to gather an understanding of the relative connectedness, prevalence, and use of their or others' electronic contact cards. The data may be presented according to selectable time-windows and/or as overall data.

FIG. 7 depicts an example user interface 700 for viewing notifications and reminders associated with electronic contact cards, according to at least one example. The notifications and reminders may include updates and requests associated with one or more additional electronic contact cards. In some examples, two individuals may have a certain number of contacts in common. In addition, this view of the application may provide for suggestions of connections based on the digital rolodexes of other users. The user interface 700 may also be used to create notes, reminders, or other actions associated with particular electronic contact cards, such as a reminder to follow up with a particular contact on a certain day and time. The notes may include information input by the user such as the relation to the user or when contact was made.

The user interface 700 may also include options for providing alerts based on reminders, such as those discussed above. Additionally, notifications may be generated by the server, a remote computing device, or another user including invitations to join particular groups, when a user has been introduced to another contact through the system, or when a user's electronic contact card is shared with a third party by a current contact within the user's digital rolodex.

In some examples, the user interface 700 may be configured for interacting with notifications or suggestions received at the mobile application and/or web-based portal. The user interface 700 may provide options to accept, reply, respond, ignore, join, connect, contact, or other actions related to the electronic contact card management system.

In some examples, the user interface 700 or other user interfaces described herein may communicate with external systems such as email clients, contact lists, directories, or other collections of contact information. The electronic contact cards and their related data and information may be stored on a remote computing device such as a server and/or in a cloud-based computing environment. The communication with external systems may ensure that an email service has up to date email addresses for contacts whose information has been changed on their electronic contact cards due to a job change or other change in contact information.

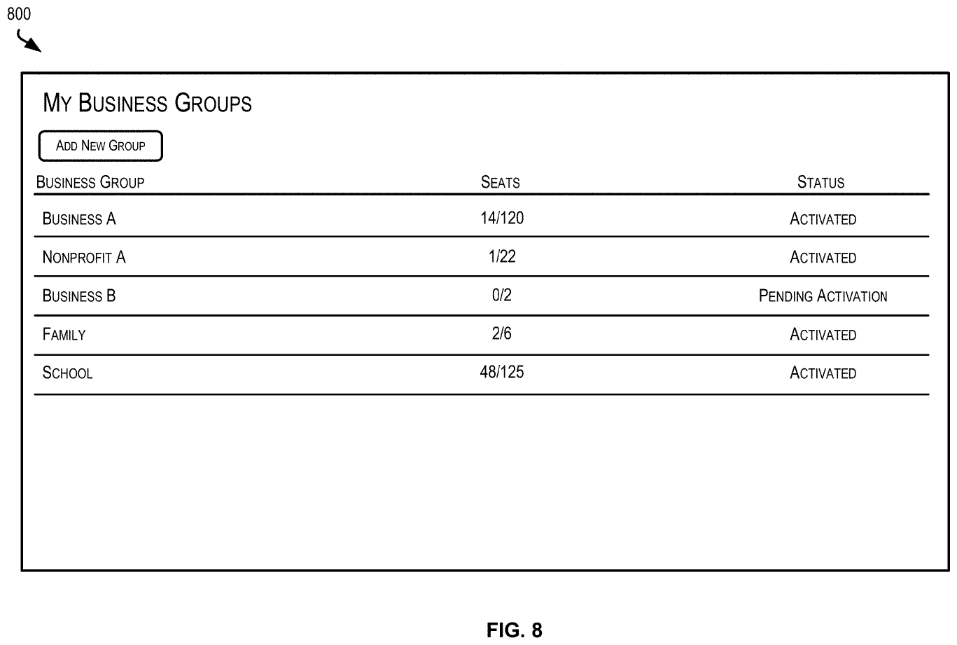

FIG. 8 depicts an example web portal 800 for managing a business group of an electronic contact management system, according to at least one example. The web portal 800 may include features and elements described herein, and the mobile application described above may also include a module for managing business groups. This web portal 800 may enables a user to manage a business group they created. For example, a human resources department, office manager, or other such individual within a company may manage electronic contact cards for employees of the company through a single account, ensuring that correct contact information, titles, and other relevant information is provided.

The web portal 800 of FIG. 8 also provides access to paid subscription module. This module allows a user to manage a paid subscription and business group. Included is a view to all electronic contact cards for users within a business group as well as an edit and/or update electronic contact card account for the entire company/organization to make global changes to each individual electronic contact card, such as when a new logo is rolled out, a merger is finalized, or a company is re-branded.

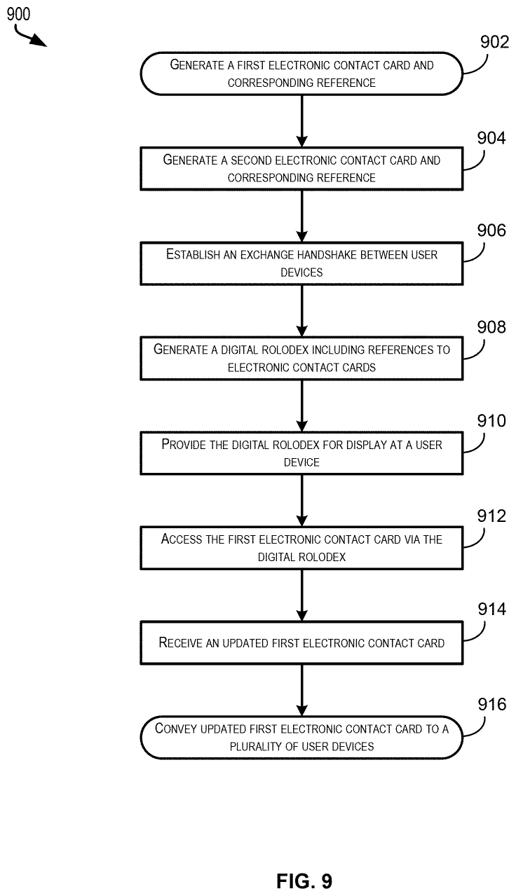

FIG. 9 depicts an example flowchart for a process 900 of exchanging electronic contact cards, according to at least one example. The process 900 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

The process 900 may begin at 902 by generating a first electronic contact card and corresponding reference indicia. The first electronic contact card may be generated using a template or using any other inputs through a user device. The first electronic contact card may be generated and stored at a database of a remote computing system. The corresponding reference indicia may include an optical code or any suitable code or reference for uniquely identifying the first electronic contact card. The first electronic contact card may be associated with a user who may have multiple electronic contact cards, such as a personal card, a business card, and other such cards.

At 904, the process 900 may include generating a second electronic contact card and corresponding reference indicia. The second electronic contact card may be generated similar to the first electronic contact card. The second electronic contact card may be associated with a second user separate from the first user and the first user device.

At 906, the process 900 may include establishing an exchange handshake between user devices. The exchange handshake may include any of the systems and methods described herein, such as through communicating over a near-field communication, BLUETOOTH®, or through an optical code sharing system, a proximity sharing device, or other such communication system.

At 908, the process 900 may include generating a digital rolodex including references to electronic contact cards. The digital rolodex may be stored at the mobile application server and may be associated with a particular user device (and an associated user) and may include a representation or reference to electronic contact cards gathered or received by the first user device.

At 910, the process 900 may include providing the digital rolodex for display at a user device. The digital rolodex may be displayed through a display of the user device, for example by displaying representations of electronic contact cards similar to business cards. The digital rolodex may be presented with additional information such as additional videos, text data, contact information, and other such information.

At 912, the process 900 may include accessing the first electronic contact card via the digital rolodex. The first electronic contact card may be accessed via the second user device, for example by selecting a link or representation of the first electronic contact card.

At 914, the process 900 may include receiving an updated first electronic contact card. The first user may update their contact card, for example with new job position data, additional contact information, and other user data. The update may be received at the remote application server 104 from the first user device.

At 916, the process 900 may include conveying an updated first electronic contact card to a plurality of user devices. The update may be conveyed to all digital rolodexes including a reference to the first electronic contact card, such as individuals who have received the first electronic contact card. In some examples a notification may indicate that the first electronic contact card has been updated may be conveyed to the first user device as well.

In some examples, the process 900 may include additional steps as described herein, including identifying user devices located within a threshold distance based on a location and providing an indication of contacts within a digital rolodex that are within the limited geographic range. In some examples a user may transmit their location to a subset or group of their digital rolodex.

In some examples, the digital rolodex may include multiple subgroups or categories that may be grouped together, for example to separate acquaintances from different aspects of a user's life. Updates or additional information may be sent to sub-groups, or contact initiated through the sub-group of the rolodex, for example to distribute information about an event organized by a user.

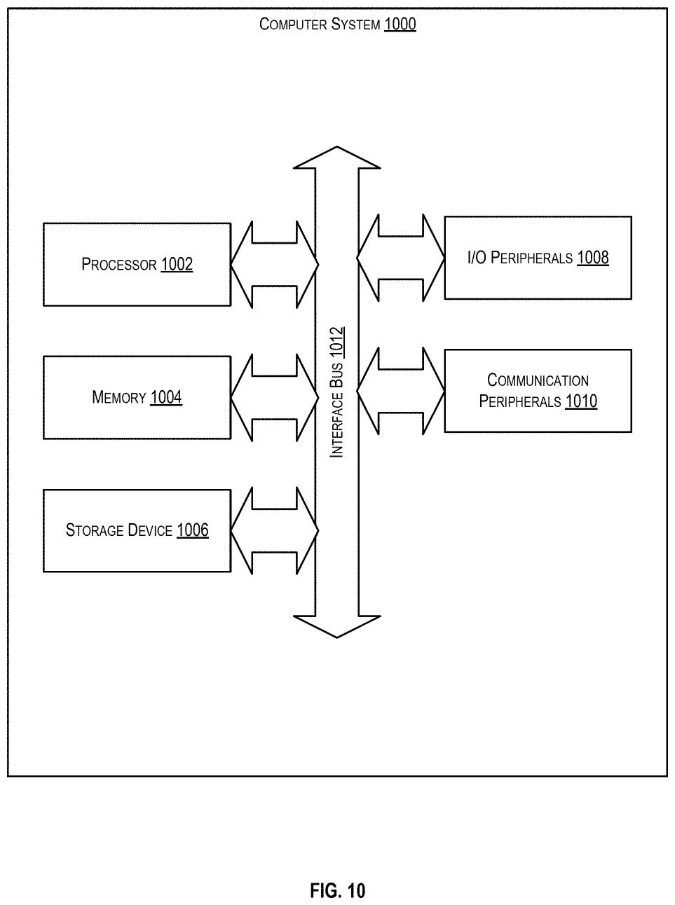

FIG. 10 illustrates examples of components of a computer system 1000 according to certain embodiments. The computer system 1000 is an example of the computer system described herein above such as the user device 102 or 202 or mobile application server 204. Although these components are illustrated as belonging to a same computer system 1000, the computer system 1000 can also be distributed.

The computer system 1000 includes at least a processor 1002, a memory 1004, a storage device 1006, input/output peripherals (I/O) 1008, communication peripherals 1010, and an interface bus 1012. The interface bus 1012 is configured to communicate, transmit, and transfer data, controls, and commands among the various components of the computer system 1000. The memory 1004 and the storage device 1006 include computer-readable storage media, such as RAM, ROM, electrically erasable programmable read-only memory (EEPROM), hard drives, CD-ROMs, optical storage devices, magnetic storage devices, electronic non-volatile computer storage, for example FLASH™ memory, and other tangible storage media. Any of such computer readable storage media can be configured to store instructions or program codes embodying aspects of the disclosure. The memory 1004 and the storage device 1006 also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the computer system 1000.

Further, the memory 1004 includes an operating system, programs, and applications. The processor 1002 is configured to execute the stored instructions and includes, for example, a logical processing unit, a microprocessor, a digital signal processor, and other processors. The memory 1004 and/or the processor 1002 can be virtualized and can be hosted within another computer system of, for example, a cloud network or a data center. The I/O peripherals 10010 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 1008 are connected to the processor 1002 through any of the ports coupled to the interface bus 1012. The communication peripherals 1010 are configured to facilitate communication between the computer system 1000 and other computing devices over a communications network and include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computer system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “including,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description.

The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A computer-implemented method for exchanging electronic contact cards, the computer-implemented method comprising:
receiving first identifying information from a first user device;
determining, by a remote computing system, a first electronic contact card associated with the first identifying information;
storing, in a first data structure associated with the first user device and stored at the remote computing system, a reference to the first electronic contact card;
generating a digital rolodex including a plurality of references to electronic contact cards including the reference to the first electronic contact card; and
providing, for display at the first user device, the digital rolodex configured for interaction and selection of the reference to the first electronic contact card;
accessing, in response to selection of the reference, the first electronic contact card; and
providing, for display at the first user device, contents of the first electronic contact card.

2. The computer-implemented method of claim 1, wherein providing contents of the first electronic contact card comprises providing a message associated with the first electronic contact card.

3. The computer-implemented method of claim 1, further comprising:
determining a location of a second user device associated with the first electronic contact card; and
providing the location of the second user device for display with contents of the first electronic contact card at the first user device.

4. The computer-implemented method of claim 1, further comprising:
selecting two or more references of the plurality of references of the digital rolodex;
determining when a second user device associated with a first reference of the one or more references of the digital rolodex is within a threshold distance of the first user device; and
providing a notification for display at the first user device in response to the second user device being within the threshold distance.

5. The computer-implemented method of claim 1, further comprising:
determining a location of the first user device; and
providing, to a plurality of user devices associated with a subset of the electronic contact cards, the location of the first user device.

6. The computer-implemented method of claim 1, wherein receiving the first identifying information from the first user device comprises receiving, via an image sensor of the first user device, the first identifying information.

7. The computer-implemented method of claim 6, wherein receiving the first identifying information comprises establishing an exchange handshake between the first user device and a second user device, wherein the second user device conveys the first identifying information to the first user device, the first user device conveys second identifying information associated with a second electronic contact card to the second user device, the first user device receives the first identifying information from the second user device, and the second user device receives the second identifying information from the first user device.

8. A computer-implemented method for exchanging electronic contact cards, the computer-implemented method comprising:
receiving, at a first user device and from a second user device, a first reference to a first electronic contact card, wherein the first electronic contact card is stored at a remote computing system in communication with the first user device and the first electronic contact card is associated with the second user device;
generating a data structure stored at the remote computing system to include an association between the first electronic contact card and the first user device;
providing, for display at the first user device, a first digital rolodex based on the data structure;
receiving, via the remote computing system, updated contact information associated with the first electronic contact card input via the second user device;
updating the first electronic contact card based on the updated contact information; and
providing, for display at the first user device, a second digital rolodex including the updated contact information.

9. The computer-implemented method of claim 8, wherein receiving the first reference comprises establishing an exchange handshake between the first user device and the second user device, wherein the first user device conveys the first reference to the second user device, the second user device conveys a second reference associated with a second electronic contact card to the first user device, the first user device receives the second reference from the second user device, and the second user device receives the first reference from the first user device.

10. The computer-implemented method of claim 9, wherein the first user device conveys the first reference by presenting a code on a display of the first user device and receives the second reference via an image sensor of the first user device.

11. The computer-implemented method of claim 8, further comprising generating, via the second user device, the first electronic contact card.

12. The computer-implemented method of claim 11, wherein generating the first electronic contact card comprises selecting a template and inputting contact information into the template.

13. The computer-implemented method of claim 8, wherein receiving the first reference comprises receiving information via a contactless communication means.

14. The computer-implemented method of claim 8, wherein receiving the first reference comprises receiving information displayed on a display of the second user device via an image sensor of the first user device.

15. A method for exchanging electronic contact cards, the method comprising:
generating, via a first user device, a first electronic contact card for storage at a remote computing system;
generating, via a second user device, a second electronic contact card for storage at the remote computing system;
establishing an exchange handshake between the first user device and the second user device, wherein the first user device conveys a first reference to the first electronic contact card, the second user device conveys a second reference to the second electronic contact card, the first user device receives the second reference, and the second user device receives the first reference;
providing a data structure at the remote computing system that includes a relational connection between the first electronic contact card and the second electronic contact card;
providing a representation of the data structure to the first user device and the second user device;
receiving, via the first user device, an updated first electronic contact card stored at the remote computing system including one or more changes to the first electronic contact card; and
conveying to the second user device, in response to receiving the updated first electronic contact card, an update to the representation of the data structure including the updated first electronic contact card.

16. The method of claim 15, wherein the first reference comprises a first optical code and the second reference comprises a second optical code and the first user device and second user device each receive respective optical codes via an image sensor of the first user device and second user device, respectively.

17. The method of claim 15, wherein the first user device conveys the first reference by presenting a code on a display of the user device and receives the second reference via an image sensor.

18. The method of claim 17, wherein the first user device presents the code and receives the second reference simultaneously.

19. The method of claim 15, wherein the exchange handshake comprises positioning the first user device within a threshold distance of the second user device.

20. The method of claim 15, wherein the exchange handshake comprises conveying the first and second references and receiving the first and second references via a near-field communication network.
